(19) United States
(12) Patent Application Publication
(10) Pub. No.: US 2020/0149631 A1
(43) Pub. Date: May 14, 2020

(54) PARKING LOCK CONTROLLER

(71) Applicant: HONDA MOTOR CO., LTD., Tokyo (JP)

(72) Inventors: Yuya Tachibanada, Wako-shi (JP); Kazuma Sasahara, Wako-shi (JP); Tetsuya Mochizuki, Wako-shi (JP); Koichi Fushimi, Wako-shi (JP); Hirotake Omoto, Wako-shi (JP); Shunsuke Yoshida, Wako-shi (JP)

(21) Appl. No.: 16/665,224

(22) Filed: Oct. 28, 2019

(30) Foreign Application Priority Data
Nov. 9, 2018 (JP) 2018-211575

(51) Int. Cl. F16H 61/30; B60T 1/00; F16H 63/34

(52) U.S. Cl. CPC F16H 61/30; F16H 63/3483; B60T 1/005

(57) ABSTRACT

When hydraulic information is not available for use, a lock mechanism control unit of a transmission's rotating shaft operated by hydraulic pressure sets the shift range to a non-running range and sets a parking lock to an unlocked state if a vehicle is in a running state and rotation speed of a drive unit is equal to or higher than a predetermined value, but sets the shift range to a parking range and sets the parking lock to a locked state if the vehicle is in a non-running state or the rotation speed is lower than the predetermined value.

### INCORPORATION BY REFERENCE

The present application claims priority under 35 U.S.C. § 119 to Japanese Patent Application No. 2018-211575 filed on Nov. 9, 2018. The content of the application is incorporated herein by reference in its entirety.

### BACKGROUND OF THE INVENTION

### Field of the Invention

The present invention relates to a parking lock controller adapted to control a hydraulic parking lock mechanism of a vehicle transmission.

### Description of the Related Art

A parking lock device keeps a vehicle in a stopped state by blocking rotation of an output shaft of an automatic transmission. The parking lock device is made up, for example, of a lock mechanism adapted to lock rotation of the output shaft and an actuator adapted to drive the lock mechanism.

Conventionally, as an actuator operated by hydraulic pressure, a parking actuator valve is known, the parking actuator valve including a piston adapted to drive a lock mechanism, and a cylinder adapted to slidably support the piston, wherein in the cylinder, oil chambers are provided at locations facing opposite end portions of the piston, respectively (Japanese Patent Laid-Open No. 2017-166637). The parking actuator valve selectively applies hydraulic pressure to the oil chambers, thereby moves the cylinder in two opposite directions, thereby drives the lock mechanism, and thereby locks and unlocks the output shaft. Here, the lock mechanism includes a parking lock gear coupled to the output shaft and a parking lock pole. The cylinder drives the parking lock pole, and locks the output shaft by engaging a projection on the parking lock pole with teeth of the parking lock gear or unlocks the output shaft by terminating the engagement.

As the hydraulic pressure for driving the parking actuator valve, hydraulic pressure from a hydraulic pump driven by an engine is used when the engine is rotating, and hydraulic pressure from a pressure accumulation chamber called an accumulator is used when the engine is stopped. The accumulator is, for example, a closed tank and accumulates hydraulic pressure when hydraulic oil is introduced into the tank under the hydraulic pressure from the hydraulic pump during the rotation of the engine.

Also, the hydraulic oil is introduced into the oil chambers of the parking actuator valve by a hydraulic control valve controlled by a valve controller. The valve controller manages hydraulic pressure introduced into the parking actuator valve and locks or unlocks a parking lock by operating the hydraulic control valve and driving the parking actuator valve under a condition that the hydraulic pressure is equal to or higher than a predetermined value.

The conventional parking actuator valve described above eliminates the need for driving by an electric motor, and thus eliminates the cost of increasing parts and enables effective use of engine room space of the vehicle.

On the other hand, in terms of operation control over the parking actuator valve, the valve controller needs to monitor hydraulic pressure, for example, with predetermined timing to ensure that the parking actuator valve operates as described above. Therefore, if, for example, hydraulic information is lost due to a power failure or the like, generally the valve controller operates the parking actuator valve such that the parking lock will remain locked at the time of subsequent power recovery in order to stop the vehicle and secure the vehicle (maintain a stop position) as safety actions in case of occurrence of abnormality.

However, if a power failure such as described above occurs, for example, during running, and the parking lock is locked by operating the parking actuator upon power restoration, the projection on the parking lock pole will not be engaged properly with the teeth of the parking lock gear and the two components may collide with each other repeatedly, causing unusual noise.

### SUMMARY OF THE INVENTION

Against the above background, in relation to a parking lock controller that controls a hydraulic parking lock mechanism unit adapted to activate a parking lock using a hydraulic actuator operated by hydraulic pressure, there is demand to prevent generation of unusual noise in the parking lock mechanism unit during a recovery operation after hydraulic information is lost during running of a vehicle while giving priority to stopping and position fixing of the vehicle.

According to one aspect of the present invention, there is provided a parking lock controller comprising: a lock mechanism control unit adapted to control a parking lock mechanism unit while acquiring hydraulic information about a state of hydraulic pressure, the parking lock mechanism unit being adapted to lock rotation of a rotating shaft of a transmission coupled to a wheel by operating on the hydraulic pressure generated when a drive unit for running a vehicle rotates; and a shift control unit adapted to control a shift range of the transmission, wherein when an abnormal condition in which the hydraulic information is not available for use occurs, under conditions that the vehicle is in a running state and that rotation speed of the drive unit is equal to or higher than a predetermined value, the lock mechanism control unit controls the parking lock mechanism unit so as to unlock the rotating shaft or maintain an unlocked state and sets the shift range to a non-running range via the shift control unit, and under a condition that the vehicle is in a non-running state or the rotation speed of the drive unit is lower than a predetermined value, the lock mechanism control unit controls the parking lock mechanism unit so as to lock the rotation of the rotating shaft and sets the shift range to a parking range via the shift control unit.

According to another aspect of the present invention, when the abnormal condition occurs, the lock mechanism control unit maintains a current state of the parking lock mechanism unit until a predetermined time period elapses after the occurrence of the abnormal condition is detected.

According to another aspect of the present invention, when the abnormal condition occurs, the lock mechanism control unit operates so as to release hydraulic pressure from the parking lock mechanism unit.

According to another aspect of the present invention, the parking lock mechanism unit includes a hydraulic actuator operated by the hydraulic pressure inside the parking lock mechanism unit, and a hydraulic control valve provided in an oil passage connected to the hydraulic actuator and adapted to control application of the hydraulic pressure inside the parking lock mechanism unit to the hydraulic actuator, and when the abnormal condition occurs, the lock mechanism control unit releases the hydraulic pressure from the parking lock mechanism unit by discharging hydraulic oil from the oil passage between the hydraulic control valve and the hydraulic actuator.

According to another aspect of the present invention, the predetermined time period is equal to or longer than a time period until information about the running state and the rotation speed becomes available.

Also, according to another aspect of the present invention, the predetermined time period is equal to or longer than a time period until a communications network on the vehicle is recovered or a time period until a state of the parking lock mechanism unit becomes determinable, whichever is longer.

According to another aspect of the present invention, the running state is determined based on a signal from a vehicle speed sensor adapted to detect vehicle speed of the vehicle and a signal from a parking position sensor adapted to detect a locked position and an unlocked position of the parking lock mechanism unit.

According to another aspect of the present invention, the abnormal condition is a failure of power supply to the parking lock controller.

According to another aspect of the present invention, there is provided a parking lock controller comprising a processing unit adapted to control a parking lock and a shift range of a vehicle, wherein: the processing unit is configured to control a parking lock mechanism unit while acquiring hydraulic information about a state of hydraulic pressure, and control a shift range of the transmission, the parking lock mechanism unit being adapted to lock rotation of a rotating shaft of a transmission coupled to a wheel by operating on the hydraulic pressure generated when a drive unit for running a vehicle rotates; when an abnormal condition in which the hydraulic information is not available for use occurs, under conditions that the vehicle is in a running state and that rotation speed of the drive unit is equal to or higher than a predetermined value, the processing unit controls the parking lock mechanism unit so as to unlock the rotating shaft or maintain an unlocked state and sets the shift range to a non-running range; and under a condition that the vehicle is in a non-running state or the rotation speed of the drive unit is lower than a predetermined value, the processing unit controls the parking lock mechanism unit so as to lock the rotation of the rotating shaft and sets the shift range to a parking range.

In a parking lock controller that controls a hydraulic parking lock mechanism unit using a hydraulic actuator, the present invention makes it possible to prevent generation of unusual noise in the parking lock mechanism unit during a recovery operation after hydraulic information is lost during running of a vehicle while giving priority to stopping and position fixing of the vehicle.

### BRIEF DESCRIPTION OF THE DRAWINGS

FIG. 1 is a diagram showing a configuration of a vehicle that uses TCU, which is a parking lock controller according to an embodiment of the present invention;

FIG. 2 is a diagram showing an exemplary configuration of a lock mechanism provided in a parking lock mechanism unit of the vehicle shown in FIG. 1;

FIG. 3 is a diagram showing a configuration of TCU, which is the parking lock controller according to the embodiment of the present invention shown in FIG. 1;

FIG. 4 is a diagram showing an example of procedures for abnormality handling actions in case hydraulic information in a storage device is lost due to a power failure in TCU, which is the parking lock controller;

FIG. 5 is a diagram showing another example of procedures for abnormality handling actions in case hydraulic information in a storage device is lost due to a power failure in TCU, which is the parking lock controller;

FIG. 6 is a diagram showing an example of a state of the parking lock mechanism unit before an abnormal condition occurs;

FIG. 7 is a diagram showing an example of a state of the parking lock mechanism unit when an abnormal condition occurs;

FIG. 8 is a diagram showing an example of a state of the parking lock mechanism unit in an initial stage of a recovery operation after an abnormal condition occurs; and

FIG. 9 is a flowchart showing operation procedures in TCU, which is the parking lock controller.

### DETAILED DESCRIPTION OF THE PREFERRED EMBODIMENT

An embodiment of the present invention will be described below with reference to the drawings.

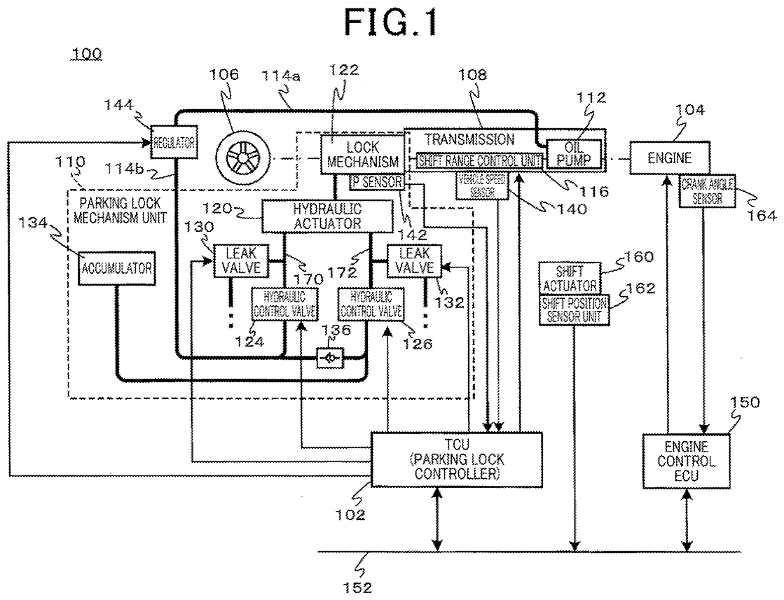

FIG. 1 is a diagram showing a configuration of a vehicle 100 that uses a parking lock controller according to an embodiment of the present invention. The parking lock controller according to the present embodiment is configured as a TCU (Transmission Control Unit) 102, which is an electronic control unit (ECU) adapted to control a transmission 108.

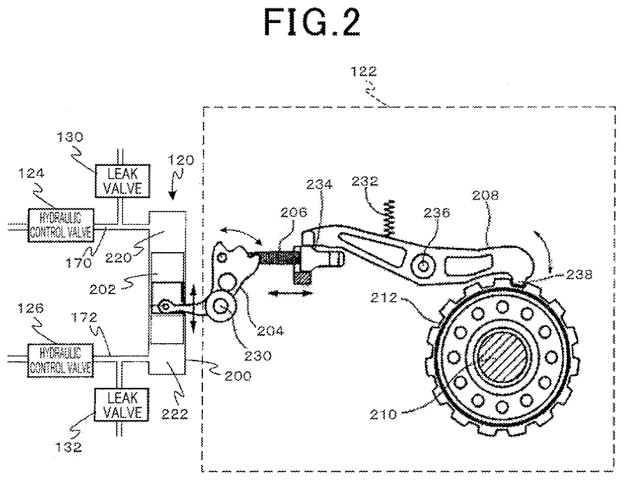

The vehicle 100 includes an engine 104 which is a drive unit for running the vehicle 100, the transmission 108, which is an automatic transmission adapted to transmit rotation of the engine 104 to a wheel 106, a parking lock mechanism unit 110 adapted to lock rotation of a rotating shaft 210 (FIG. 2), which is a rotating shaft of the transmission 108 and is coupled directly or indirectly to the wheel 106, and an oil pump 112 driven by the engine 104. Note that the parking lock mechanism unit 110 may be configured integrally with the transmission 108 as part of the transmission 108.

The transmission 108 includes a shift range control unit 116 adapted to control a shift range, and a vehicle speed sensor 140. According to the present embodiment, specifically the vehicle speed sensor 140 detects rotation speed of the rotating shaft of the transmission 108. However, this is merely an example, and the vehicle 100 may have any vehicle speed sensor 140 installed at any location suitable for the purpose of vehicle speed detection. For example, the vehicle speed sensor 140 can be designed to detect rotation speed of the wheel 106 directly. Also, for example, the rotating shaft of the transmission 108 used by the vehicle speed sensor 140 to detect the rotation speed may be an input shaft, output shaft, or driven shaft of the transmission 108, where the driven shaft rotates following the input shaft.

The oil pump 112 is driven, for example, by the rotation of the engine 104 and supplies oil to various members in the transmission 108, the various members needing lubrication and hydraulic supply for shift range control in the transmission 108 and control over the parking lock mechanism unit 110. An oil passage for the oil sent out from the oil pump 112 branches (bifurcation is not shown) to an oil passage 114a and hydraulic pressure from the oil pump 112 is applied to the oil passage 114a.

The oil passage 114a is connected with a regulator 144 adapted to convert given hydraulic pressure in the oil passage 114a into a predetermined hydraulic pressure lower than the given hydraulic pressure and output the predetermined hydraulic pressure to an oil passage 114b. The regulator 144 operates in response to hydraulic instructions specifying the predetermined hydraulic pressure sent from a TCU 102 and outputs the predetermined hydraulic pressure to the oil passage 114b. Note that although the regulator 144 is described as being an independent device in the present embodiment, but may be provided in the transmission 108.

The hydraulic pressure in the oil passage 114b is inputted to the parking lock mechanism unit 110 and used for operation of a hydraulic actuator 120. However, for example, if the rotation of the engine 104 stops and the hydraulic pressure outputted from the oil pump 112 to the oil passage 114a is lower than the predetermined hydraulic pressure, low hydraulic pressure that does not reach the predetermined hydraulic pressure is outputted to the oil passage 114b. In this case, the parking lock mechanism unit 110 is able to perform a locking operation by being provided with hydraulic pressure from an accumulator 134 described later.

The parking lock mechanism unit 110 operates on hydraulic pressure provided from the oil passage 114b. That is, the parking lock mechanism unit 110 locks or unlocks the rotation of the rotating shaft of the transmission 108 coupled to the wheel 106 by operating on hydraulic pressure generated when the engine 104, which is a drive unit for running a vehicle, rotates.

Specifically, the parking lock mechanism unit 110 is equipped with the hydraulic actuator 120 adapted to operate on hydraulic pressure provided from an oil pump 112 through the oil passage 114a, regulator 144, and oil passage 114b when the oil pump 112 rotates along with the rotation of the engine 104. Also, the parking lock mechanism unit 110 includes a lock mechanism 122, part (specifically, a parking gear 212 (FIG. 2)) of which is coupled to the rotating shaft 210 of the transmission 108 coupled directly or indirectly to the wheel 106. Here, configurations of the hydraulic actuator 120, lock mechanism 122, and the like driven by the hydraulic actuator 120 are described, for example, in Japanese Patent Laid-Open No. 2017-166637.

The hydraulic actuator 120 has a configuration similar to that of a parking actuator valve described, for example, in Japanese Patent Laid-Open No. 2017-166637. The hydraulic actuator 120 operates when hydraulic pressure is selectively applied via hydraulic control valves 124 and 126 to respective oil chambers 220 and 222 (FIG. 2) provided in opposite end portions of a cylinder 200 of a piston 202 adapted to drive the lock mechanism 122. The hydraulic control valves 124 and 126 are, for example, normally-open (i.e., open in a non-energized state) solenoid valves whose operation is controlled by the TCU 102.

The parking lock mechanism unit 110 also includes leak valves 130 and 132 provided, respectively, in the oil passages 170 and 172 between hydraulic control valves 124 and 126 and the hydraulic actuator 120. The leak valves 130 and 132, for example, normally-closed (i.e., closed in a non-energized state) solenoid valves, are controlled by the TCU 102, and discharge hydraulic oil, respectively, from the oil passages 170 and 172 between the hydraulic control valves 124 and 126 and the hydraulic actuator 120.

The parking lock mechanism unit 110 includes the accumulator 134, which is an accumulator adapted to accumulate hydraulic pressure provided from the oil pump 112. The accumulator 134 is connected to the oil passage 114b leading to a hydraulic control valve 126. Also, a check valve 136 is provided between the hydraulic control valves 126 and 124, the check valve 136 being adapted to transmit hydraulic pressure from the hydraulic control valve 124 to the hydraulic control valve 126, but not to transmit hydraulic pressure in a direction from the hydraulic control valve 126 to the hydraulic control valve 124. Consequently, when the engine 104 stops and operation of the oil pump 112 stops, the hydraulic pressure causing the hydraulic actuator 120 to perform a locking operation is provided to the hydraulic control valve 126 by the accumulator 134 instead of the oil pump 112.

However, after the oil pump 112 stops, the hydraulic pressure accumulated in the accumulator 134 decreases gradually with time. Consequently, when a predetermined time period (e.g., ten-odd minutes) elapses after the oil pump 112 stops, the accumulator 134 becomes unable to output enough hydraulic pressure to operate the hydraulic actuator 120.

Therefore, if, for example, the rotation of the engine 104 stops and the hydraulic pressure outputted from the oil pump 112 to the oil passage 114a remains lower than the predetermined hydraulic pressure for the predetermined time period, hydraulic pressure outputted from the accumulator 134 also becomes lower than the predetermined hydraulic pressure. Thus, when the rotation of the engine 104 stops, using the hydraulic pressure outputted from the accumulator 134, the TCU 102 described later moves a lock mechanism of the parking lock mechanism unit 110 to a lock position after hydraulic pressure in the oil passage 114b decreases, but before the hydraulic pressure outputted from the accumulator 134 decreases gradually and falls below hydraulic pressure needed for operation of the hydraulic actuator 120. In so doing, if the vehicle 100 is running, unusual noise such as described earlier could be generated in the lock mechanism 122 until vehicle speed falls to or below a predetermined vehicle speed.

The parking lock mechanism unit 110 also includes a parking position sensor (P sensor) 142 adapted to detect whether the lock mechanism 122 is in a locked state, i.e., whether the rotating shaft 210 of the transmission 108 coupled to the wheel 106 is locked by the lock mechanism 122 (i.e., secured by parking lock).

The vehicle 100 also includes an engine control ECU 150, which is an electronic control unit adapted to control operation of the engine 104. The engine control ECU 150 measures rotation speed of the engine 104 based on information acquired from a crank angle sensor 164 provided on the engine 104 and generates and outputs engine rotation speed information. Also, the engine control ECU 150 controls operation of the engine by controlling a valve opening degree of a suction valve (not shown) of the engine 104 and ignition timing of an ignition plug (not shown) used to burn fuel, based on information on a current crank angle from the crank angle sensor 164, information on an amount of driver's accelerator pedal depression acquired, for example, from an accelerator sensor (not shown), and other information.

Furthermore, the vehicle 100 includes a shift actuator 160 (e.g., a shift lever or shift operation button) manipulated by the driver and a shift position sensor unit 162 adapted to detect and output shift position information indicating a shift range currently set on the shift actuator 160. The shift position sensor unit 162 is configured, for example, as an electronic control unit (ECU).

The TCU 102, engine control ECU 150, and shift position sensor unit 162 are connected with one another in a communications-ready state via a network bus 152 making up a communications network configured to communicate among electronic control units in the vehicle 100. The network bus 152 is, for example, a CAN (Control Area Network) bus used for communications in conformity with the CAN communications standard.

The TCU 102 measures current vehicle speed of the vehicle 100 based on a signal acquired from the vehicle speed sensor 140 and generates vehicle speed information. Also, the TCU 102 receives a signal from the P sensor 142 and generates lock status information indicating whether the parking lock is activated by the lock mechanism 122. Furthermore, via the network bus 152, the TCU 102 acquires the engine rotation speed information outputted by the engine control ECU 150 and acquires the shift position information from the shift position sensor unit 162. Then, based on the vehicle speed information, lock status information, engine rotation speed information, and/or shift position information, the TCU 102 controls shifting of the transmission gear of the transmission 108 and controls operation of the parking lock mechanism unit 110 based on a state of the hydraulic pressure in the oil passage 114b as well.

FIG. 2 is a diagram showing an exemplary configuration of the lock mechanism 122. However, this is merely an example, and the lock mechanism 122 may have any mechanism capable of locking and unlocking rotation of the wheel 106 by means of a hydraulic actuator. In the example of FIG. 2, the lock mechanism 122 includes a detent plate 204 driven by the piston 202 sliding in the cylinder 200 of the hydraulic actuator 120, a parking rod 206, a parking pole 208, and a parking gear 212 provided on the rotating shaft 210 of the transmission 108 coupled directly or indirectly to the wheel 106.

To move the piston 202 upward (or downward) in FIG. 2, the hydraulic control valve 124 (or 126) is closed and the hydraulic control valve 126 (or 124) is opened and the leak valve 130 on the side of the closed hydraulic control valve 124 (or 126) is opened, thereby discharging hydraulic oil from the oil passage 170 (or 172). Note that the hydraulic oil discharged from the leak valve 130 or 132 is returned into the transmission 108 by flowing, for example, through a non-illustrated route.

Note that non-illustrated leak flow paths adapted to conduct when the hydraulic control valves 124 and 126 are closed may be provided in those parts of the hydraulic control valves 124 and 126 which are connected with the oil passages 170 and 172, respectively. With this configuration, when the hydraulic control valve 124 (or 126) is closed and the hydraulic control valve 126 (or 124) is opened, the hydraulic oil is discharged from the oil passage 170 (or 172) through the leak flow path of the closed hydraulic control valve 124 (or 126), causing the piston 202 to move upward (or downward) in FIG. 2.

As shown in FIG. 2, when the hydraulic control valve 126 and leak valve 130 are closed and the hydraulic control valve 124 and leak valve 132 are opened, hydraulic pressure higher than in the oil chamber 222 is applied to the oil chamber 220 above the cylinder 200 in FIG. 2, causing the piston 202 to move downward in FIG. 2. Consequently, the detent plate 204 rotates leftward around a spindle 230, causing the parking rod 206 to move leftward. Consequently, a left-side end portion (in FIG. 2) of the parking pole 208 biased downward in FIG. 2 by a spring 232 slides down a cam 234 of the parking rod 206, causing the parking pole 208 to rotate leftward around a spindle 236. As a result, a locking pawl 238, which is a projection provided in a right end portion (in FIG. 2) of the parking pole 208 is disengaged from the parking gear 212, and the rotating shaft 210 is freed from the lock (from rotation blocking) (i.e., unlocked).

On the other hand, to shift the rotating shaft 210 from an unlocked state to a locked state shown in FIG. 2, with the hydraulic control valve 124 and leak valve 132 closed and with the hydraulic control valve 126 and leak valve 130 opened, hydraulic pressure higher than in the oil chamber 220 is applied to the oil chamber 222, causing the piston 202 to move upward in FIG. 2 and performing an operation opposite the operation described above. That is, when the piston 202 moves upward, the detent plate 204 rotates rightward. Consequently, a left end of the parking pole 208 rotates rightward by sliding up the cam 234 of the parking rod 206 and the locking pawl 238 at a right end of the parking pole 208 get engaged with the parking gear 212, locking the rotating shaft 210.

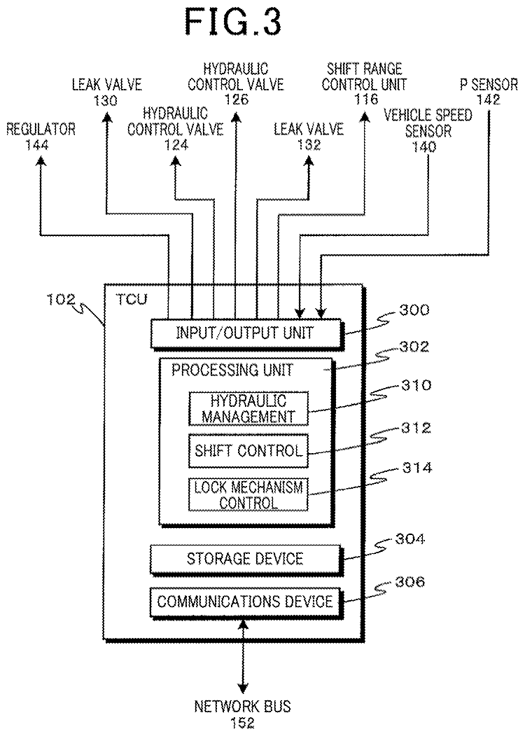

FIG. 3 is a diagram showing a configuration of the TCU 102. The TCU 102 includes an input/output unit 300, a processing unit 302, a storage device 304, and a communications device 306. The input/output unit 300 is an input/output interface adapted to exchange signals between the processing unit 302 and devices, sensors, or apparatuses external to the TCU 102. Specifically, the processing unit 302 transmits signals for operation control to the regulator 144, the hydraulic control valves 124 and 126, leak valves 130 and 132, and the shift range control unit 116 of the transmission 108 via the input/output unit 300 and receives signals from the vehicle speed sensor 140 and P sensor 142.

The storage device 304 is made up of a non-volatile memory or a non-volatile memory and volatile memory and stores data needed for processing performed by the processing unit 302. The communications device 306 is a transmitter-receiver used to communicate with another electronic control unit such as the engine control ECU 150 via the network bus 152. Specifically, for example, when the network bus 152 is a CAN bus, the communications device 306 is a CAN transceiver adapted to conduct communications in accordance with the CAN communications standard.

The processing unit 302 is a computer that includes, for example, a processor such as a CPU (Central Processing Unit), a ROM (Read Only Memory) in which programs have been written, and a RAM (Random Access Memory) for temporary storage of data. Besides, the processing unit 302 includes a hydraulic management unit 310, a shift control unit 312, and a lock mechanism control unit 314 as functional elements (or functional units).

These functional elements of the processing unit 302 are implemented, for example, when the processing unit 302, which is a computer, executes programs. Note that the computer programs can be prestored in any computer-readable storage medium.

Alternatively, all or part of the functional elements of the processing unit 302 may be implemented by pieces of hardware, each of which contains one or more electronic circuit components.

For example, at the time or after the TCU 102 is turned on, each time the engine 104 is started the hydraulic management unit 310 transmits hydraulic instructions to the regulator 144, instructing the regulator 144 to output a predetermined hydraulic pressure to the oil passage 114b. Here, based on the engine rotation speed information transmitted from the engine control ECU 150, when the rotation speed of the engine 104 indicated by the engine rotation speed information becomes equal to or higher than a predetermined value, the hydraulic management unit 310 determines that the engine 104 has been started.

Also, when a predetermined time period elapses after transmission of the hydraulic instructions to the regulator 144, the hydraulic management unit 310 determines that hydraulic pressure enough (or necessary) to output hydraulic pressure equal to (or higher than) the predetermined hydraulic pressure has been accumulated in the accumulator 134 as a result of introduction of hydraulic oil into the accumulator 134. Then, the hydraulic management unit 310 stores hydraulic information in the storage device 304, indicating that the enough or necessary hydraulic pressure is accumulated in the accumulator 134 (i.e., that the hydraulic pressure is normal), and starts a timer (not shown) to start measuring an elapsed time from the storage. Here, the hydraulic information indicates whether a predetermined hydraulic pressure will be secured even after the oil pump 112 stops and corresponds to hydraulic information that indicates a state of hydraulic pressure used to operate the parking lock mechanism unit 110.

Subsequently, based on the engine rotation speed information transmitted from the engine control ECU 150, the hydraulic management unit 310 determines at predetermined time intervals whether the rotation speed of the engine 104 is equal to or higher than a predetermined value, and if the rotation speed is equal to or higher than the predetermined value, the hydraulic management unit 310 continues transmitting hydraulic instructions and determines that the enough or necessary hydraulic pressure remains accumulated in the accumulator 134. Then, based on results of the determination, the hydraulic management unit 310 updates the hydraulic information stored in the storage device 304, resets the timer, and newly starts measuring an elapsed time from the update.

Based on a shift position signal received from the shift position sensor unit 162 and instructions from the lock mechanism control unit 314, the shift control unit 312 of the TCU 102 transmits a shift instruction signal to the shift range control unit 116 of the transmission 108 and thereby controls the shift range of the transmission 108.

The lock mechanism control unit 314 controls the parking lock mechanism unit 110 while acquiring the hydraulic information stored in the storage device 304 by the hydraulic management unit 310. Specifically, the lock mechanism control unit 314 acquires engine rotation speed information from the engine control ECU 150 via the network bus 152, for example, at predetermined time intervals and controls the parking lock mechanism unit 110 using the acquired engine rotation speed information, vehicle speed information generated based on a signal from the vehicle speed sensor 140 and lock status information generated based on a signal from the P sensor 142, and the hydraulic information stored in the storage device 304 by the hydraulic management unit 310.

More specifically, upon receiving shift position information from the shift position sensor unit 162, the lock mechanism control unit 314 determines whether the shift range has been set to a parking range and whether the shift range has been switched from the parking range to another shift range. The shift position information is transmitted to the TCU 102 from the shift position sensor unit 162, for example, in response to manipulation of the shift actuator 160 by the driver.

Also, when the engine rotation speed indicated by the engine rotation speed information is equal to or higher than a predetermined rotation speed and it is determined that the engine 104 is in an operating state, the lock mechanism control unit 314 determines that the hydraulic pressure provided to the parking lock mechanism unit 110 through the oil passage 114b is normal.

Then, when it is determined that the hydraulic pressure is normal, if the shift actuator 160 is set to the parking range, the lock mechanism control unit 314 instructs the parking lock mechanism unit 110 to lock the rotating shaft 210 of the wheel 106. Specifically, the lock mechanism control unit 314 instructs the hydraulic control valves 124 and 126 to close the hydraulic control valve 124 and leak valve 132 and open the hydraulic control valve 126 and leak valve 130 and drives the hydraulic actuator 120, engaging the parking pole 208 of the lock mechanism 122 with teeth of the parking gear 212 and thereby locking the rotating shaft 210 of the wheel 106.

Also, when it is determined, such as described above, that the hydraulic pressure is normal, if the shift actuator 160 is switched from the parking range to another shift range, the lock mechanism control unit 314 instructs the parking lock mechanism unit 110 to unlock the rotating shaft 210 of the wheel 106. Specifically, with the hydraulic control valve 126 and leak valve 130 closed and the hydraulic control valve 124 and leak valve 132 opened, the lock mechanism control unit 314 drives the hydraulic actuator 120, disengaging the parking pole 208 of the lock mechanism 122 from the teeth of the parking gear 212 and thereby unlocking the rotating shaft 210 of the wheel 106.

On the other hand, when it is determined that the engine rotation speed indicated by the engine rotation speed information is lower than the predetermined rotation speed, by referring to the hydraulic information stored in the storage device 304, the lock mechanism control unit 314 instructs the parking lock mechanism unit 110 to lock the rotating shaft 210 of the wheel 106 before a predetermined time period elapses from an update time of the hydraulic information (i.e., while hydraulic pressure enough or necessary to operate the hydraulic control valve 126 remains in the accumulator 134). Here, the predetermined time period can be adaptively set by the lock mechanism control unit 314 based on a hydraulic value indicated by the hydraulic information stored in the storage device 304 (i.e., hydraulic reading just registered by the regulator 144).

Furthermore, according to the present embodiment, the lock mechanism control unit 314 takes abnormality handling actions when an abnormal condition in which hydraulic information is not available for use occurs in particular. Here, such an abnormal condition can develop when hydraulic information stored in the storage device 304 is lost for example, due to a power failure such as instantaneous interruption of power supply to the TCU 102, which is the parking lock controller according to the present embodiment, generation of a large noise, or other influences.

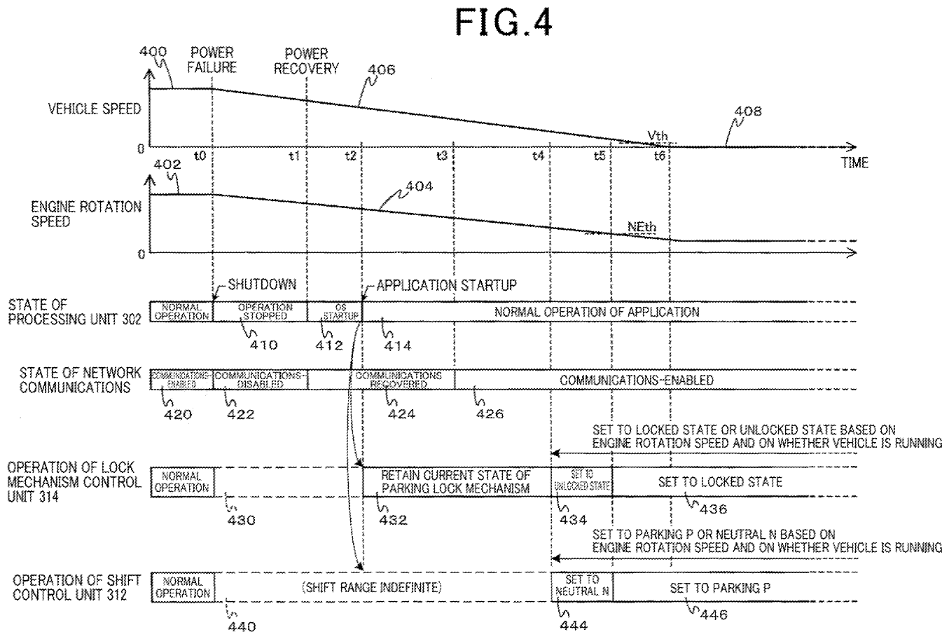

FIG. 4 is a diagram showing, as an example, procedures for abnormality handling actions in case hydraulic information in the storage device 304 is lost due to a power failure in the TCU 102. In the illustrated example, it is assumed that a power failure of the TCU 102 occurs at time t0, and that power supply to the TCU 102 is recovered, for example, at time t1.

FIG. 4 shows changes over time in vehicle speed of the vehicle 100, rotation speed of the engine 104, state of the processing unit 302 of the TCU 102, state of network communications of the TCU 102 via the network bus 152, operation of the lock mechanism control unit 314 of the processing unit 302, and operation of the shift control unit 312 in order from the top.

Until time t0 at which a power failure of the TCU 102 occurs, for example, the engine rotation speed of the engine 104 is constant (reference number: 402) and the vehicle 100 is running at a constant speed (reference number: 400). Subsequently, when, for example, an electronic control unit (not shown) controlling the engine 104 performs control so as to reduce the rotation speed of the engine 104 as a result of the power failure, the engine rotation speed decreases gradually (reference number: 404). Also, when driving force transmission gears of the transmission 108 are disengaged as a result of the power failure, power of the engine 104 is not transmitted to the wheel 106, and the vehicle speed decreases due to running resistance as well (reference number: 406).

The processing unit 302 of the TCU 102 stops operation due to the power failure at time t0 (reference number: 410). Consequently, the shift control unit 312 and lock mechanism control unit 314 implemented by execution of application software on the processing unit 302 cease to exist, terminating their operations (reference numbers: 430 and 440). Also, as a result of the power failure, the shift range in the transmission 108 enters an indefinite state. Generally, the indefinite state can be a state in which driving force of an output shaft of the engine 104 is not transmitted to the wheel 106.

Subsequently, when power is recovered at time t1, first, the processing unit 302 starts an operating system (OS) (reference number: 412). Next, at time t2 when the OS startup is completed, the processing unit 302 executes application programs, thereby building the shift control unit 312 and lock mechanism control unit 314, and makes these units start operation (reference number: 414).

On the other hand, the network communications of the TCU 102 via the network bus 152 changes from a then-existing communications-enabled state (reference number: 420) to a communications-disabled state (reference number: 422) as the communications device 306 of the TCU 102 is shut down at time t0. Subsequently, when the TCU 102 performs a communications recovery operation (e.g., initialization of the communications device 306) upon power recovery at t1 (reference number: 424), the network communications recovers to a communications-enabled state at time t3 (reference number: 426).

The lock mechanism control unit 314 starts operation at time t2, and upon detecting a loss of hydraulic information by accessing the storage device 304, maintains a state of the parking lock mechanism unit 110 (specifically, a state of the lock mechanism 122) at a current state (reference number: 432).

Here, in maintaining the parking lock mechanism unit 110 (specifically, the lock mechanism 122) at the current state, the lock mechanism control unit 314 releases the hydraulic pressure from an oil passage in the parking lock mechanism unit 110. That is, the lock mechanism control unit 314 controls the parking lock mechanism unit 110 such that hydraulic pressure will not be applied to the hydraulic actuator 120.

Specifically, for example, after closing the hydraulic control valves 124 and 126, by opening the leak valves 130 and 132, the lock mechanism control unit 314 discharges hydraulic oil from the oil passages 170 and 172 between the hydraulic control valves 124 and 126 and the hydraulic actuator 120 and thereby releases the hydraulic pressure from the parking lock mechanism unit 110. This ensures that a shift to a locked state or unlocked state in the parking lock mechanism unit 110 will be made properly. Note that after the hydraulic oil is discharged from the oil passages 170 and 172, the leak valves 130 and 132 are closed promptly.

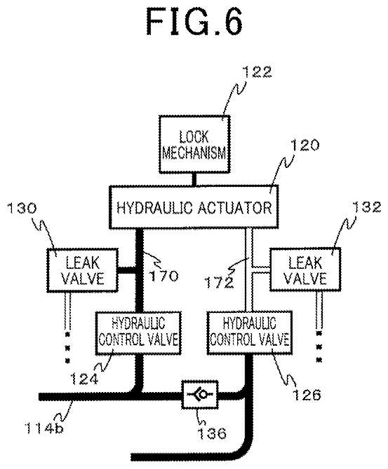

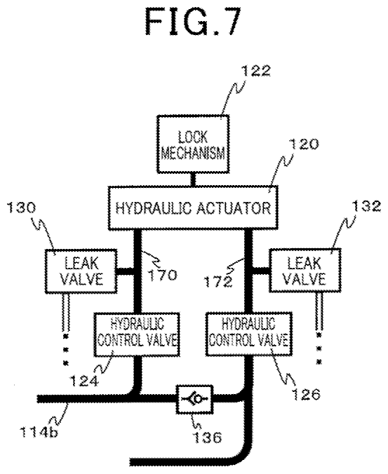

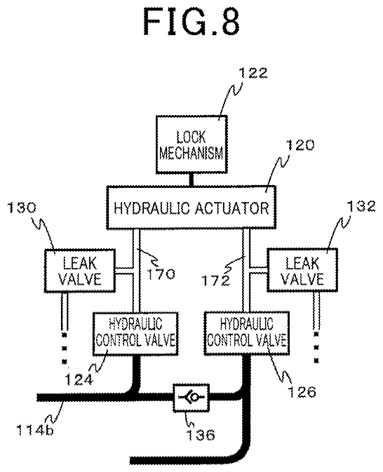

FIGS. 6 to 8 are diagrams showing examples of a control operation of the parking lock mechanism unit 110. FIG. 6 is a diagram showing an example of a state of the parking lock mechanism unit 110 before an abnormal condition occurs, FIG. 7 is a diagram showing an example of a state of the parking lock mechanism unit 110 when an abnormal condition occurs, and FIG. 8 is a diagram showing an example of a state of the parking lock mechanism unit 110 in an initial stage (time t2 to time t3) of a recovery operation after an abnormal condition occurs.

In the example shown in FIG. 6, before an abnormal condition involving a loss of hydraulic information occurs, the hydraulic control valve 124 is opened resulting in application of hydraulic pressure to the oil passage 170 and the hydraulic control valve 126 is closed resulting in a release of hydraulic pressure from the oil passage 172, and consequently the parking lock mechanism unit 110 enters an unlocked state. Note that in FIGS. 6 to 8, the oil passages 170 and 172 are shown by black lines to indicate application of hydraulic pressure, and shown by hollow lines to indicate released hydraulic pressure.

In the state shown in FIG. 6, if a loss of hydraulic information in the TCU 102 occurs due to, for example, a power failure, the hydraulic control valves 124 and 126 can be deenergized. Consequently, the state of the hydraulic actuator 120 upon power recovery can be such that hydraulic pressure is being applied from both the oil passages 170 and 172 as shown in FIG. 7, for example, because the hydraulic control valves 124 and 126 remain open by being deenergized as a result of the power failure. In this case, for example, even if the lock mechanism control unit 314 closes the hydraulic control valve 124 and opens the hydraulic control valve 126 to engage the parking lock operation after restoration of power supply, if the hydraulic pressure in the oil passage 114b has not reached a level needed for appropriate operation of the hydraulic actuator 120 (e.g., if the hydraulic pressure provided to the oil passage 172 by the oil passage 114b is higher than the hydraulic pressure accumulated in the oil passage 170) because of a shortage of time for the recovery, the hydraulic actuator 120 may unintentionally move slightly to an unlocking direction once. The movement is not so large as to unlock the lock mechanism 122, but desirably the movement is prevented to ensure more reliable operation.

Therefore, according to the present embodiment, as shown in FIG. 8, the hydraulic oil is discharged from the oil passages 170 and 172 between the hydraulic control valves 124 and 126 and the hydraulic actuator 120 via the leak valves 130 and 132, thereby releasing the hydraulic pressure applied to the hydraulic actuator 120 from the oil passages 170 and 172. Consequently, according to the present embodiment, the hydraulic actuator 120 is set once to a state in which hydraulic pressure is not applied from the oil passages 170 and 172, and then the hydraulic actuator 120 is set to operate properly through introduction of hydraulic oil into the oil passages 170 and 172 to ensure proper shifts to a locked state and unlocked state of the parking lock mechanism unit 110. Note that the hydraulic oil discharged through the leak valves 130 and 132 is returned into the transmission 108 by flowing, for example, through non-illustrated routes.

Referring to FIG. 4, the lock mechanism control unit 314 starts retaining the state of the parking lock mechanism unit 110 at time t2 when the loss of the hydraulic information is detected and continues retaining the state to time t4 at which a predetermined time period elapses from time t2 (reference number: 432).

The predetermined time period can be equal to or longer than a time period until information about engine rotation speed and information about running state becomes available in the TCU 102 (specifically, in the lock mechanism control unit 314).

As described later, the lock mechanism control unit 314 controls the parking lock mechanism unit 110 based on the engine rotation speed information acquired from the engine control ECU 150 via the network bus 152 and communications device 306 and on the running state of the vehicle 100 determined from the vehicle speed information and lock status information. Therefore, by setting the predetermined time period equal to or longer than the time period until information about engine rotation speed and information about running state becomes available as described above, it is possible to control the parking lock mechanism unit 110 properly.

Here, as described above, in retaining the state of the parking lock mechanism unit 110, if the hydraulic oil in the oil passages 170 and 172 are discharged through the leak valves 130 and 132, a differential pressure can be generated between the oil passage 170 and oil passage 172 due to a speed difference between the discharges from the oil passages 170 and 172. As a result, in the process of discharging hydraulic oil through the leak valves 130 and 132, the piston 202 of the hydraulic actuator 120 could move transiently. Therefore, if lock status information is generated by acquiring a signal from the P sensor 142 just when such a transient movement of the piston 202 occurs, the running state could be determined erroneously.

Therefore, the predetermined time period for which the state of the parking lock mechanism unit 110 is retained can more specifically be equal to or longer than either of the following, whichever is longer: the time period from the time of a shutdown due to, for example, a power failure until power supply is restored, the TCU 102 is restarted, and functions of the communications device 306 are restored (i.e., the time until communications over the communications network on the vehicle 100 via the network bus 152 are restored, making engine rotation speed information available) and the time period until the transient movement of the piston 202 in the hydraulic actuator 120 terminates, making the state of the parking lock mechanism unit 110 determinable.

Referring to FIG. 4, the lock mechanism control unit 314 acquires the engine rotation speed information from the engine control ECU 150 via the network bus 152 at time t4 at which the predetermined time period elapses from time t2 at which startup of the processing unit 302 is started. Also, the lock mechanism control unit 314 determines whether the vehicle 100 is in a running state based on the vehicle speed information and lock status information generated by the lock mechanism control unit 314 from the signals from the vehicle speed sensor 140 and P sensor 142. Specifically, the lock mechanism control unit 314 determines that the vehicle 100 is in a running state when the current vehicle speed indicated by the vehicle speed information is equal to or higher than Vth and the lock mechanism 122 is in an unlocked state according to the lock status information. Also, when the current vehicle speed indicated by the vehicle speed information is lower than Vth or when it is indicated that the lock mechanism 122 is in a locked state, the lock mechanism control unit 314 determines that the vehicle 100 is not in a running state.

Then, based on the acquired engine rotation speed information and on the determination as to whether the vehicle 100 is in a running state, the lock mechanism control unit 314 instructs the shift control unit 312 to set the parking lock mechanism unit 110 to a locked state or unlocked state and set the shift range of the transmission 108 to a non-running range (e.g., a neutral range N) or a parking range P.

Specifically, when the vehicle 100 is in a running state and the engine rotation speed indicated by the engine rotation speed information is equal to or higher than a predetermined value NEth, the lock mechanism control unit 314 sets the parking lock mechanism unit 110 to an unlocked state or maintains an unlocked state (i.e., unlocks the lock or maintains an unlocked state) and instructs the shift control unit 312 to set the shift range to the neutral range N, which is a non-running range.

On the other hand, when the vehicle 100 is not in a running state or the engine rotation speed is lower than the predetermined value NEth, the lock mechanism control unit 314 sets the parking lock mechanism unit 110 to a locked state and instructs the shift control unit 312 to set the shift range to the parking range P.

That is, according to the present embodiment, even in a running state, if the engine rotation speed is equal to or higher than a predetermined value NEth, the hydraulic pressure in the oil passage 114b is estimated to be restored to a predetermined hydraulic pressure soon, and thus the shift range is set to the neutral range N to secure a restoration period of hydraulic pressure without locking the parking lock mechanism unit 110. Consequently, the present embodiment makes it possible to prevent unusual noise that could be generated if the parking lock mechanism unit 110 is locked indiscriminately just after recovery from an abnormal condition and ensure smooth operation free of unusual noise in a subsequent locking operation of the parking lock mechanism unit 110.

Also, according to the present embodiment, when the vehicle 100 is not in a running state, because there is a low probability that the locking operation of the parking lock mechanism unit 110 will cause unusual noise, the parking lock mechanism is locked and the shift range is set to parking range P as described above. Also, according to the present embodiment, when the engine rotation speed is lower than the predetermined value NEth and the hydraulic pressure in the oil passage 114b is not expected to be restored, even if the vehicle 100 is in a running state and unusual noise could occur, the parking lock mechanism unit 110 is set to a locked state as described above, giving priority to stopping and position fixing of the vehicle 100.

The above operation allows the TCU 102, which is the parking lock controller according to the present embodiment to prevent generation of unusual noise in the parking lock mechanism unit 110 while giving priority to stopping of the vehicle 100 and position fixing of the vehicle 100 during a recovery operation after hydraulic information is lost during running of the vehicle.

Furthermore, according to the present embodiment, since the control over the parking lock mechanism unit 110 is started when a predetermined time period elapses after detection of abnormality, after communications disruption of sensor information, which is likely to have occurred along with the abnormal condition, is recovered, the parking lock mechanism unit 110 can be controlled properly by precisely grasping information such as engine rotation speed information, vehicle speed information, and lock status information used to determine the operating state of the engine 104 of the vehicle 100 and the running state of the vehicle 100.

Also, according to the present embodiment, as described above, the determination of the running state of the vehicle 100 is made based on the vehicle speed information generated from a signal from the vehicle speed sensor 140 adapted to detect the vehicle speed of the vehicle 100 and the lock status information generated from a signal from the P sensor (parking position sensor) 142 adapted to detect a locked position and unlocked position of the lock mechanism 122 of the parking lock mechanism unit 110.

Consequently, the present embodiment makes it possible to avoid an erroneous determination of a running state due to a failure and the like of the vehicle speed sensor 140. However, the above configuration is merely an example, and the vehicle 100 may be determined to be running based solely on vehicle speed information, e.g., only when the current vehicle speed is Vth or above.

Here, in the example of FIG. 4, it is assumed that the lock mechanism 122 remains unlocked until time t4.

At time t4, the lock mechanism control unit 314 acquires engine rotation speed information from the engine control ECU 150. Also, the lock mechanism control unit 314 generates vehicle speed information based on a signal from the vehicle speed sensor 140 and generates lock status information based on a signal from the P sensor 142. Then, the lock mechanism control unit 314 recognizes that the lock mechanism 122 is in an unlocked state based on the lock status information and recognizes that the current vehicle speed is equal to or higher than the predetermined value Vth based on the vehicle speed information, and determines that the vehicle 100 is in a running state. Note that after time t4, the lock mechanism control unit 314 repeats the acquisition of engine rotation speed information from the engine control ECU 150, generation of vehicle speed information and lock status information, and determination as to whether the vehicle 100 is in a running state at predetermined time intervals.

Based on the engine rotation speed information acquired at time t4, the lock mechanism control unit 314 recognizes that the engine rotation speed is equal to or higher than the predetermined value NEth. Consequently, since the engine rotation speed is equal to or higher than the predetermined value NEth and the vehicle 100 is in a running state, the lock mechanism control unit 314 sets the lock mechanism 122 to an unlocked state by controlling the parking lock mechanism unit 110 (reference number: 434).

At the same time, the lock mechanism control unit 314 instructs the shift control unit 312 to set the shift range to neutral N. Consequently, the shift control unit 312 sets the shift range to neutral N (reference number: 444).

Subsequently, when the engine rotation speed falls below NEth, for example, at time t5, the lock mechanism control unit 314 recognizes, from the engine rotation speed information acquired periodically from the engine control ECU 150, that the engine rotation speed has fallen below NEth. Consequently, the lock mechanism control unit 314 sets the lock mechanism 122 to a locked state by controlling the parking lock mechanism unit 110 (reference number: 436).

At the same time, the lock mechanism control unit 314 instructs the shift control unit 312 to set the shift range to parking range P. Consequently, the shift control unit 312 sets the shift range to parking range P (reference number: 446). As a result, at time t6 when the vehicle speed falls below Vth and then down to zero, the vehicle 100 has its position fixed (reference number: 408).

Note that although it has been stated in FIG. 4 that an abnormal condition in which hydraulic information is not available for use by the TCU 102 occurs due to a failure of power supply to the TCU 102, this is not restrictive. An abnormal condition in which hydraulic information is not available for use can occur from any cause such as a loss of hydraulic information from the storage device 304 as a result of external noise.

In the case of an abnormal condition caused by reasons other than a power failure, after the occurrence of the abnormal condition, the TCU 102 can perform a process similar to a process after time t2 in FIG. 4. That is, the lock mechanism control unit 314 maintains a current state of the parking lock mechanism unit 110 until a predetermined time period elapses after the occurrence of the abnormal condition is detected. Subsequently, the lock mechanism control unit 314 sets the parking lock mechanism unit 110 to an unlocked state or locked state based on the running state and engine speed of the vehicle 100 and instructs the shift control unit 312 to set the shift range to neutral N or parking range P.

Note that even in the case of an abnormal condition caused by something other than a power failure, by taking a possibility of occurrence of an abnormal operation of a device or the like, other than the TCU 102 (e.g., the engine control ECU 150), the predetermined time period may be set, for example, to a sufficient time period for communications via the network bus 152 to be restored as described above.

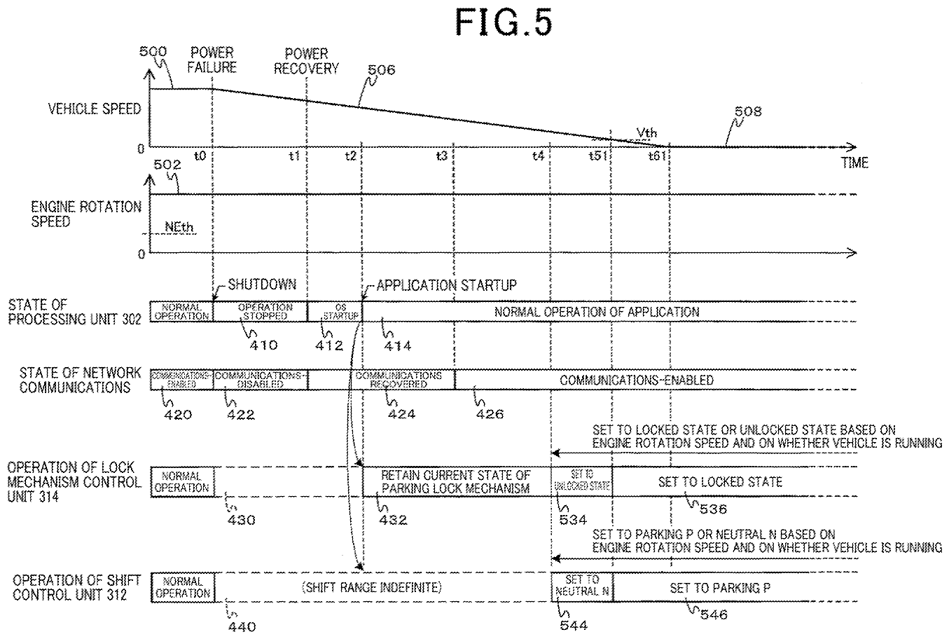

FIG. 5 is a diagram showing another example of procedures for abnormality handling actions in case hydraulic information in the storage device 304 is lost due to a power failure in the TCU 102. As with FIG. 4, FIG. 5 shows changes over time in vehicle speed of the vehicle 100, rotation speed of the engine 104, state of the processing unit 302 of the TCU 102, state of network communications of the TCU 102 via the network bus 152, operation of the lock mechanism control unit 314 of the processing unit 302, and operation of the shift control unit 312 in order from the top. Also, in FIG. 5, as with FIG. 4, it is assumed that a power failure occurs at time t0.

However, in the example shown in FIG. 5, unlike the example of FIG. 4, the rotation speed of the engine 104 is maintained at a fixed rotation speed higher than the predetermined value NEth even after the power failure (reference number: 502). Also, the vehicle speed is constant until the power failure at time t0 (reference number: 500), but after the power failure at time t0, as driving force transmission gears of the transmission 108 are disengaged as a result of the power failure, power of the engine 104 is not transmitted to the wheel 106, and consequently the vehicle speed decreases due to running resistance (reference number: 506).

In the example of FIG. 5, the state of the processing unit 302 and state of network communications follow a course similar to the example shown in FIG. 4. Also, the operation of the lock mechanism control unit 314 and operation of the shift control unit 312 (including the actions at time t4) shown in FIG. 5 are similar to those in FIG. 4 until time t4. Therefore, in FIG. 5, the description in FIG. 4 above apply to meanings of t1, t2, t3, and t4, the state of the processing unit 302, the state of network communications, and the operation of the lock mechanism control unit 314 and operation of the shift control unit 312 (including the actions at time t4) until time t4. Also, as with the example of FIG. 4, after time t4, the lock mechanism control unit 314 repeats the acquisition of engine rotation speed information from the engine control ECU 150, generation of vehicle speed information and lock status information, and determination as to whether the vehicle 100 is in a running state at predetermined time intervals (i.e., periodically).

In the example shown in FIG. 5, since the engine rotation speed is kept at a value equal to or higher than the predetermined value NEth, the lock mechanism control unit 314 maintains the unlock setting made to the lock mechanism 122 (reference number: 534) and the neutral N setting made to the shift range (reference number: 544) at time t4 until the vehicle speed reaches the predetermined value Vth subsequently. Then, when the vehicle speed falls below the predetermined value Vth at time t51, based on the vehicle speed information and lock status information generated periodically, the lock mechanism control unit 314 determines that the vehicle 100 has entered a non-running state and sets the lock mechanism 122 to a locked state by controlling the parking lock mechanism unit 110 (reference number: 536).

At the same time, the lock mechanism control unit 314 instructs the shift control unit 312 to set the shift range to parking range P. Consequently, the shift control unit 312 sets the shift range to parking range P (reference number: 546). As a result, at time t61 when the vehicle speed falls below Vth and then down to zero, the vehicle 100 has its position fixed (reference number: 508).

Note that the predetermined value Vth may be set to zero. In this case, at time t51 when the vehicle speed reaches Vth (i.e., zero) and the vehicle 100 stops (or immediately after the stop), the lock mechanism control unit 314 sets the lock mechanism 122 to a locked state and instructs the shift control unit 312 to set the shift range to parking range P.

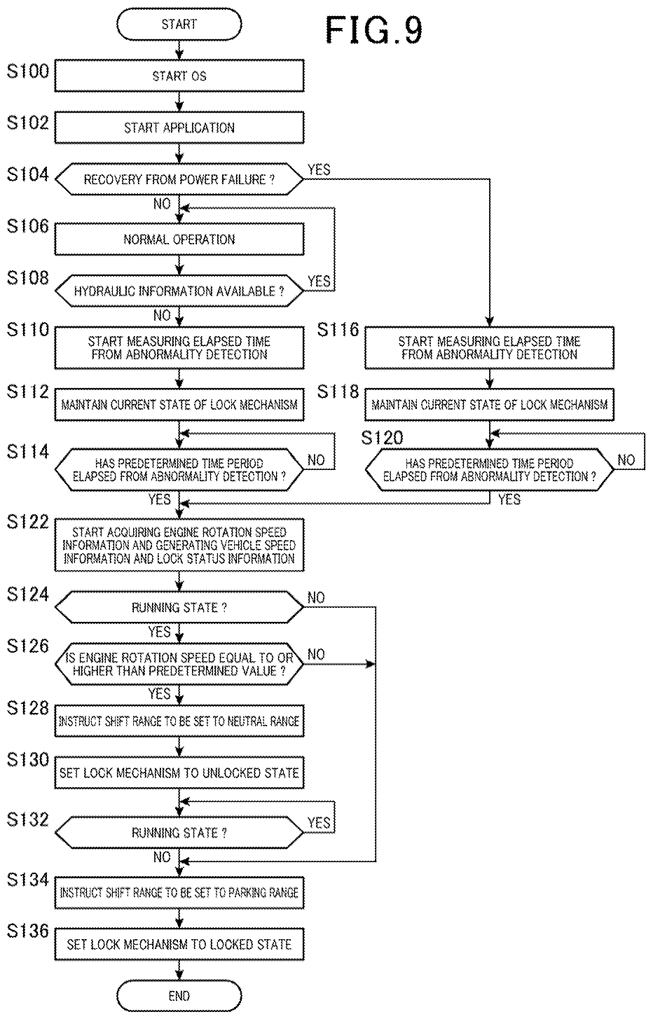

Next, operation procedures of the TCU 102, which is the parking lock controller, will be described with reference to a flowchart of FIG. 9. The process starts when the TCU 102 is powered on. The present process ends when processing is finished according to the flowchart of FIG. 9 or the TCU 102 is powered off. Note that concurrently with the process shown in FIG. 9, the processing unit 302 of the TCU 102 acquires engine rotation speed information from the engine control ECU 150 via the communications device 306 and generates vehicle speed information and lock status information based on the signals from the vehicle speed sensor 140 and P sensor 142, for example, at predetermined time intervals. Also, concurrently with this, the processing unit 302 of the TCU 102 updates the hydraulic information stored in the storage device 304 based on the acquired engine rotation speed information, for example, at predetermined time intervals and measures an elapsed time from the update using a timer.

When the process is started, the TCU 102 starts the operating system (OS) (S100), and then starts and execute application programs (S102). Consequently, the TCU 102 builds the shift control unit 312 and lock mechanism control unit 314 and starts operation of these units.

Next, the lock mechanism control unit 314 of the TCU 102 determines whether the current startup follows upon recovery from a power failure (S104). Regarding the determination as to whether the current startup follows upon recovery from a power failure, for example, if the processing unit 302 writes a predetermined code into a non-volatile memory, which is part of the storage device 304, at the end of normal power supply in the TCU 102 and the predetermined code cannot be read from the non-volatile memory at the next power-on, it can be determined that the power-on is a recovery operation after a power failure.

Then, if the current startup has resulted from recovery from a power failure (S104: YES), the lock mechanism control unit 314 determines that abnormality has been detected and starts measuring an elapsed time from the detection of the abnormality (S116). Next, the lock mechanism control unit 314 maintains a current state of the lock mechanism 122 by controlling the parking lock mechanism unit 110 (S118). As described above, to maintain the current state of the lock mechanism 122, the lock mechanism control unit 314 closes the hydraulic control valves 124 and 126 of the parking lock mechanism unit 110 and opens the leak valves 130 and 132, thereby discharging hydraulic oil from the oil passages 170 and 172.

Then, the lock mechanism control unit 314 determines whether the elapsed time from the abnormality detection has exceeded a predetermined time period (S120), where the elapsed time has started being counted in step S116. If the predetermined time period has not been exceeded (S120: NO), the lock mechanism control unit 314 returns to step S120 and waits until the predetermined time period elapses. On the other hand, when the elapsed time from the abnormality detection has exceeded the predetermined time period (S120: YES), the lock mechanism control unit 314 starts acquiring engine rotation speed information from the engine control ECU 150 via the communications device 306 and generating vehicle speed information and lock status information based on the signals from the vehicle speed sensor 140 and P sensor 142 periodically (S122).

On the other hand, if it is determined in step S104 that the current startup is not a result of recovery from a power failure, i.e., if the current startup has resulted from power-on after a normal end (S104: NO), the lock mechanism control unit 314 performs normal operation (S106). That is, based on shift position information transmitted from the shift position sensor unit 162, the lock mechanism control unit 314 of the TCU 102 sets the lock mechanism 122 to a locked state or unlocked state by controlling the parking lock mechanism unit 110.

In normal operation, the lock mechanism control unit 314 determines whether hydraulic information is available for use (S108). When hydraulic information is available for use (S108: YES), the lock mechanism control unit 314 returns to step S106 and continues normal operation. Thus, as long as hydraulic information is available for use in step S108, the TCU 102 repeats the normal operation of step S106. The normal operation ends when the TCU 102 is powered off through normal procedures or it is determined in step S108 that hydraulic information is not available for use.

Here, whether hydraulic information is available for use can be determined, for example, by the lock mechanism control unit 314 by accessing the storage device 304 at predetermined time intervals and determining whether the hydraulic information stored in the storage device 304 has been deleted or is old one that has passed a predetermined time period or longer. Note that whether the hydraulic information has passed a predetermined time period or longer can be determined, for example, from an elapsed time indicated by a timer started by the hydraulic management unit 310 when the hydraulic information was stored in the storage device 304. When the hydraulic information stored in the storage device 304 has been deleted or is old one that has passed the predetermined time period or longer, the lock mechanism control unit 314 determines that this is an abnormal condition in which no hydraulic information is available for use.

If it is determined in step S108 that hydraulic information is not available for use (S108: NO), the lock mechanism control unit 314 determines that abnormality has been detected and starts measuring an elapsed time from the detection of the abnormality (S110). Then, as with step S118, the lock mechanism control unit 314 maintains a current state of the lock mechanism 122 by controlling the parking lock mechanism unit 110 (S112).

Next, the lock mechanism control unit 314 determines whether the elapsed time from the abnormality detection has exceeded a predetermined time period (S114), where the elapsed time has started being counted in step S110. If the predetermined time period has not been exceeded (S114: NO), the lock mechanism control unit 314 returns to step S114 and waits until the predetermined time period elapses. On the other hand, when the elapsed time from the abnormality detection has exceeded the predetermined time period (S114: YES), the lock mechanism control unit 314 moves to step S122 and starts acquiring engine rotation speed information and generating lock status information periodically.

Next, the lock mechanism control unit 314 determines whether the vehicle 100 is in a running state (S124) based on the vehicle speed information and lock status information that have started being generated periodically in step S122. Then, if the vehicle 100 is in a running state (S124: YES), the lock mechanism control unit 314 determines next whether current engine rotation speed is equal to or higher than the predetermined value NEth (S126) based on the engine rotation speed information that has started being acquired periodically in step S122.

If the engine rotation speed is equal to or higher than the predetermined value NEth (S126: YES), the lock mechanism control unit 314 instructs the shift control unit 312 to set the shift range of the transmission 108 to neutral N (S128). At the same time, the lock mechanism control unit 314 sets the lock mechanism 122 to an unlocked state by controlling the parking lock mechanism unit 110 (S130).

Subsequently, the lock mechanism control unit 314 determines, as with step S124, whether the vehicle 100 is in a running state (S132). If the vehicle 100 is in a running state (S132: YES), the lock mechanism control unit 314 returns to step S132 and waits until the vehicle 100 enters a non-running state.

On the other hand, if the vehicle 100 is in a non-running state in step S132 (S132: NO), the lock mechanism control unit 314 instructs the shift control unit 312 to set the shift range of the transmission 108 to parking range P (S134). At the same time, the lock mechanism control unit 314 sets the lock mechanism 122 to a locked state by controlling the parking lock mechanism unit 110 (S136). Consequently, the vehicle 100 enters a stopped state.

After setting the lock mechanism 122 to a locked state in step S136, the TCU 102 finishes the present process.

On the other hand, if the vehicle 100 is not in a running state in step S124 (S124: NO), the lock mechanism control unit 314 moves to step S134 regardless of the engine rotation speed and sets the lock mechanism 122 of the parking lock mechanism unit 110 to a locked state while instructing the shift control unit 312 to set the shift range of the transmission 108 to parking range P.

On the other hand, if the engine rotation speed is lower than the predetermined value NEth in step S126 (S126: NO), the lock mechanism control unit 314 also moves to step S134 and sets the lock mechanism 122 of the parking lock mechanism unit 110 to a locked state while instructing the shift control unit 312 to set the shift range of the transmission 108 to parking range P.

Note that the present invention is not limited to the configuration of the above embodiment, and may be implemented in various forms without departing from the spirit and scope of the invention.

For example, according to the present embodiment, at the time of recovery from an abnormal condition in which hydraulic information is not available for use, if the engine rotation speed is equal to or higher than the predetermined value NEth and the vehicle 100 is in a running state, the parking lock mechanism unit 110 is set to an unlocked state and the shift range is set to the neutral range N, but this is not restrictive. In this case, the shift range may be set to another range as long as a restoration period of the hydraulic pressure in the oil passage 114b can be secured. For example, according to a running state of the vehicle 100 at the time of recovery from an abnormal condition, the shift range may be set to driving range D or reverse range R to continue forward driving or reverse driving of the vehicle 100 in a natural manner upon the recovery.

Also, according to the present embodiment, the engine 104 is used as a drive unit adapted to drive the vehicle 100, but this is not restrictive. The drive unit is not limited to the engine 104, and may be any drive unit that can give a driving force to the vehicle 100. For example, a motor may be used as a drive unit instead of or in addition to the engine 104. In this case, rotation speed inputted to the transmission 108 from the engine 104 and/or motor may be used instead of the engine rotation speed used in the above description.

Also, according to the present embodiment, the parking lock mechanism unit 110 includes the parking actuator valve described in Japanese Patent Laid-Open No. 2017-166637, as the hydraulic actuator 120, and the lock mechanism 122 driven by the hydraulic actuator 120 conforms to the configuration described in Japanese Patent Laid-Open No. 2017-166637, but this is not restrictive. The parking lock mechanism unit 110 may use a hydraulic actuator of another type as long as the actuator is operated by hydraulic pressure. Also, the lock mechanism 122 may lock the rotating shaft 210 coupled to the wheel 106 by another method.

Also, according to the present embodiment, the leak valves 130 and 132 are provided separately from the hydraulic control valves 124 and 126, but this is not restrictive. For example, the leak valves 130 and 132 may be configured integrally with the hydraulic control valves 124 and 126, respectively.

As described above, the TCU 102, which is the parking lock controller according to the present embodiment, includes the lock mechanism control unit 314 adapted to control the parking lock mechanism unit 110 while acquiring the state of the hydraulic information about the state of hydraulic pressure, where the parking lock mechanism unit 110 locks the rotation of the rotating shaft 210 of the transmission 108 coupled to the wheel 106 by being operated by the hydraulic pressure generated by the rotation of the engine 104, which is a drive unit for running the vehicle 100. Also, the TCU 102 includes the shift control unit 312 adapted to control the shift range of the transmission 108 of the vehicle 100.

Then, when an abnormal condition in which hydraulic information is not available for use occurs, under conditions that the vehicle 100 is in a running state and that the rotation speed of the engine 104 is equal to or higher than a predetermined value, the lock mechanism control unit 314 controls the parking lock mechanism unit 110 so as to unlock the rotating shaft 210 or maintain an unlocked state and sets the shift range to a non-running range via the shift control unit 312. Also, when the abnormal condition occurs, under a condition that the vehicle 100 is in a non-running state or the rotation speed of the engine 104 is lower than the predetermined value NEth, the lock mechanism control unit 314 controls the parking lock mechanism unit 110 so as to lock the rotation of the rotating shaft 210 and sets the shift range to the parking range P via the shift control unit 312.

In other words, the TCU 102, which is a parking lock controller, includes the processing unit 302 adapted to control the parking lock and shift range of the vehicle 100. The processing unit 302 is configured to control the parking lock mechanism unit 110 while acquiring hydraulic information about the state of the hydraulic pressure, and control the shift range of the transmission 108 of the vehicle 100, where the parking lock mechanism unit 110 locks the rotation of the rotating shaft 210 of the transmission 108 by being operated by the hydraulic pressure generated by the rotation of the engine 104, which is a drive unit for running the vehicle 100.

Also, when an abnormal condition in which hydraulic information is not available for use occurs, under conditions that the vehicle 100 is in a running state and that the rotation speed of the engine 104 is equal to or higher than the predetermined value NEth, the processing unit 302 controls the parking lock mechanism unit 110 so as to unlock the rotating shaft 210 or maintain an unlocked state and sets the shift range to a non-running range. Also, the processing unit 302 is configured to control the parking lock mechanism unit 110 so as to lock the rotation of the rotating shaft 210 and set the shift range to the parking range under a condition that the vehicle 100 is in a non-running state or the rotation speed of the engine 104 is lower than the predetermined value NEth.

With these configurations, even in a running state, if the engine rotation speed is equal to or higher than the predetermined value NEth, by setting the shift range to the neutral range N without locking the parking lock mechanism unit 110, it is possible to prevent generation of unusual noise in the parking lock mechanism unit 110 during subsequent locking operation while securing a restoration period of the hydraulic pressure. Also, when the engine rotation speed is lower than the predetermined value NEth and the hydraulic pressure in the oil passage 114b is not expected to be restored, even if the vehicle 100 is in a running state and unusual noise could occur, the parking lock mechanism unit 110 is set to a locked state and the shift range is set to parking range P, thereby giving priority to stopping and position fixing of the vehicle 100. This makes it possible to prevent generation of unusual noise in the parking lock mechanism unit 110 while giving priority to stopping of the vehicle 100 and position fixing of the vehicle 100 during a recovery operation after hydraulic information is lost during running of the vehicle.

Also, in the TCU 102, when the abnormal condition occurs, the lock mechanism control unit 314 maintains a current state of the parking lock mechanism unit 110 until a predetermined time period elapses after the occurrence of the abnormal condition is detected. Specifically, the predetermined time period is equal to or longer than the time period until information about running state and engine rotation speed becomes available.

More specifically, the predetermined time period is equal to or longer than a time period until a communications network on the vehicle 100 using the network bus 152 is recovered or a time period until the state of the parking lock mechanism unit 110 becomes determinable, whichever is longer.

With this configuration, for example, after waiting until communications disruption of sensor information, which is likely to have occurred along with the occurrence of abnormal condition, is corrected, the parking lock mechanism 110 can be controlled properly by precisely grasping information such as engine rotation speed information, vehicle speed information, and lock status information used to determine the operating state of the engine 104 of the vehicle 100 and the running state of the vehicle 100.

Also, in the TCU 102, when the abnormal condition occurs, the lock mechanism control unit 314 operates so as to release hydraulic pressure from the parking lock mechanism unit 110. Specifically, the parking lock mechanism unit 110 includes the hydraulic actuator 120 operated by the hydraulic pressure inside the parking lock mechanism unit 100, and the hydraulic control valves 124 and 126 provided in an oil passage connected to the hydraulic actuator 120 and adapted to control application of the hydraulic pressure inside the parking lock mechanism unit 110 to the hydraulic actuator 120. Then, when the abnormal condition occurs, the lock mechanism control unit 314 discharges the hydraulic oil from the oil passages 170 and 172 between the hydraulic control valves 124 and 126 and the hydraulic actuator 120, thereby releasing hydraulic pressure from the parking lock mechanism unit 110.

With this configuration, the hydraulic actuator 120 is set once to a state in which pressure is not applied from the oil passages 170 and 172, and then the hydraulic actuator 120 is set to operate properly through subsequent introduction of hydraulic oil into the oil passages 170 and 172, making it possible to ensure proper shifts to a locked state and unlocked state of the parking lock mechanism unit 110.

Also, in the TCU 102, the determination of the running state is made based on signals from the vehicle speed sensor 140 adapted to detect the vehicle speed of the vehicle 100 and the parking position sensor 142 adapted to detect the locked position and unlocked position of the parking lock mechanism unit 110.

This configuration makes it possible to avoid making an erroneous determination of a running state due to a failure and the like of the vehicle speed sensor 140 and thereby avoid unlocking the parking lock mechanism unit 110 erroneously.

Examples of abnormal conditions in which hydraulic information is not available for use include a failure of power supply to the TCU 102, which is the parking lock controller. This configuration makes it possible to prevent generation of unusual noise in the parking lock mechanism unit 110 and avoid wear and tear of the parking lock mechanism unit 110 if a power failure occurs temporarily during running of the vehicle 100 due to a poor contact of a terminal halfway along a power supply path leading to the TCU 102.

### REFERENCE SIGNS LIST

100 . . . vehicle; 102 . . . TCU; 104 . . . engine; 106 . . . wheel; 108 . . . transmission; 110 . . . parking lock mechanism unit; 112 . . . oil pump; 114a, 114b, 170, 172 . . . oil passage; 116 . . . shift range control unit; 120 . . . hydraulic actuator; 122 . . . lock mechanism; 124, 126 . . . hydraulic control valve; 130, 132 . . . leak valve; 134 . . . accumulator; 136 . . . check valve; 140 . . . vehicle speed sensor; 142 . . . parking position sensor (P sensor); 144 . . . regulator; 150 . . . engine control ECU; 152 . . . network bus; 160 . . . shift actuator; 162 . . . shift position sensor unit; 164 . . . crank angle sensor; 200 . . . cylinder; 202 . . . piston; 204 . . . detent plate; 206 . . . parking rod; 208 . . . parking pole; 210 . . . rotating shaft; 212 . . . parking gear; 220, 222 . . . oil chamber; 230, 236 . . . spindle; 232 . . . spring; 234 . . . cam; 238 . . . locking pawl; 300 . . . input/output unit; 302 . . . processing unit; 304 . . . storage device; 306 . . . communications device; 310 . . . hydraulic management unit; 312 . . . shift control unit; 314 . . . lock mechanism control unit

What is claimed is:

1. A parking lock controller comprising:
a lock mechanism control unit adapted to control a parking lock mechanism unit while acquiring hydraulic information about a state of hydraulic pressure, the parking lock mechanism unit being adapted to lock rotation of a rotating shaft of a transmission coupled to a wheel by operating on the hydraulic pressure generated when a drive unit for running a vehicle rotates; and
a shift control unit adapted to control a shift range of the transmission,
wherein when an abnormal condition in which the hydraulic information is not available for use occurs,
under conditions that the vehicle is in a running state and that rotation speed of the drive unit is equal to or higher than a predetermined value, the lock mechanism control unit controls the parking lock mechanism unit so as to unlock the rotating shaft or maintain an unlocked state and sets the shift range to a non-running range via the shift control unit, and
under a condition that the vehicle is in a non-running state or the rotation speed of the drive unit is lower than a predetermined value, the lock mechanism control unit controls the parking lock mechanism unit so as to lock the rotation of the rotating shaft and sets the shift range to a parking range via the shift control unit.

2. The parking lock controller according to claim 1, wherein when the abnormal condition occurs, the lock mechanism control unit maintains a current state of the parking lock mechanism unit until a predetermined time period elapses after the occurrence of the abnormal condition is detected.

3. The parking lock controller according to claim 1, wherein when the abnormal condition occurs, the lock mechanism control unit operates so as to release hydraulic pressure from the parking lock mechanism unit.

4. The parking lock controller according to claim 3, wherein:
the parking lock mechanism unit includes a hydraulic actuator operated by the hydraulic pressure inside the parking lock mechanism unit, and a hydraulic control valve provided in an oil passage connected to the hydraulic actuator and adapted to control application of the hydraulic pressure inside the parking lock mechanism unit to the hydraulic actuator; and
when the abnormal condition occurs, the lock mechanism control unit releases the hydraulic pressure from the parking lock mechanism unit by discharging hydraulic oil from the oil passage between the hydraulic control valve and the hydraulic actuator.

5. The parking lock controller according to claim 2, wherein the predetermined time period is equal to or longer than a time period until information about the running state and the rotation speed becomes available.

6. The parking lock controller according to claim 5, wherein the predetermined time period is equal to or longer than a time period until a communications network on the vehicle is recovered or a time period until a state of the parking lock mechanism unit becomes determinable, whichever is longer.

7. The parking lock controller according to claim 1, wherein the running state is determined based on a signal from a vehicle speed sensor adapted to detect vehicle speed of the vehicle and a signal from a parking position sensor adapted to detect a locked position and an unlocked position of the parking lock mechanism unit.

8. The parking lock controller according to claim 3, wherein the abnormal condition is a failure of power supply to the parking lock controller.

9. A parking lock controller comprising a processing unit adapted to control a parking lock and a shift range of a vehicle, wherein:
the processing unit is configured to control a parking lock mechanism unit while acquiring hydraulic information about a state of hydraulic pressure, and control a shift range of a transmission of the vehicle, the parking lock mechanism unit being adapted to lock rotation of a rotating shaft of a wheel by operating on the hydraulic pressure generated when a drive unit for running a vehicle rotates;
when an abnormal condition in which the hydraulic information is not available for use occurs, under conditions that the vehicle is in a running state and that rotation speed of the drive unit is equal to or higher than a predetermined value, the processing unit controls the parking lock mechanism unit so as to unlock the rotating shaft or maintain an unlocked state and sets the shift range to a non-running range; and
under a condition that the vehicle is in a non-running state or the rotation speed of the drive unit is lower than a predetermined value, the processing unit controls the parking lock mechanism unit so as to lock the rotation of the rotating shaft and sets the shift range to a parking range.
